(19) United States
(12) Patent Application Publication
(10) Pub. No.: US 2023/0202687 A1
(43) Pub. Date: Jun. 29, 2023

(54) ROTORCRAFT AND METHOD FOR CONTROLLING ORIENTATION THEREOF

(71) Applicant: AERONEXT INC., Shibuya-ku (JP)

(72) Inventor: Yoichi SUZUKI, Shibuya-ku (JP)

(21) Appl. No.: 18/001,052

(22) PCT Filed: Jun. 8, 2020
(86) PCT No.: PCT/JP2020/022551

§ 371 Date: Dec. 7, 2022

(51) Int. Cl. B64U 10/16; B64U 70/83; B64U 60/30

(52) U.S. Cl. CPC B64U 10/16; B64U 70/83; B64U 60/30

(57) ABSTRACT

The present disclosure relates to a rotorcraft. The rotorcraft according to the present disclosure has a parachute mechanism for releasing a parachute in a predetermined direction and an attitude control means for setting the aircraft to a specific attitude when releasing said parachute. According to such a configuration, the parachute can be deployed in an attitude suitable for its deployment, thereby reducing damage, etc., that may occur when the flying vehicle falls.

### TECHNICAL FIELD

The present disclosure relates to a rotorcraft equipped with a parachute and an attitude control method for the rotorcraft.

### BACKGROUND ART

In recent years, the industry using drones, unmanned aerial vehicles (UAVs), and other flying vehicles (hereinafter collectively referred to as “flying vehicles”) has developed remarkably, and various services such as aerial photography, delivery, and inspection have been attempting to use flying vehicles, with each service working toward practical application and further development.

As the range of utilization of flying vehicles, especially multicopters with multiple rotor blades, expands, there is an urgent need to improve their safety. When flying over the sky, it is necessary to assume a falling accident, etc. Patent Literature 1 discloses a flying vehicle equipped with a parachute. (See, for example, Patent Literature 1).

Patent Literature 1 provides a rotorcraft with a parachute or paraglider deployment device that can be deployed in a shorter time (see, e.g., Patent Literature 1).

### PRIOR ART LIST

### Patent Literature

[Patent Document 1] Japanese Unexamined Patent Application Publication No. 2020-59315

### SUMMARY OF INVENTION

### Technical Problem

In Patent Literature 1, a parachute or paraglider can be ejected and deployed using gas pressure when an abnormality is detected by the abnormality detection device. This can reduce the speed of the fall and reduce damage to the flying vehicle and the property to which it is to fall.

In a flying vehicle equipped with a parachute deployment mechanism such as the one in this document, it is important to deploy the parachute correctly.

However, when existing flying vehicles actually fall, the parachute deployment direction is not always upward. In such cases, for example, the parachute may not be able to deploy properly because it is caught on a part of the flying vehicle, or the parachute or its connecting string may be cut by a propeller or other sharp part, causing the fuselage and parachute to separate, and the parachute may not be fully effective.

Therefore, one object of the present disclosure is to provide a rotorcraft equipped with means to bring the falling fuselage to a predetermined attitude so that the parachute or canopy (hereinafter collectively referred to as “parachute”) can be deployed more normally in the event of an anomaly or failure of the aircraft in flight.

### Technical Solution

According to the present disclosure, the following is provided.

A rotorcraft equipped with a plurality of rotor blades, comprising:

a parachute mechanism that releases a parachute in a predetermined direction; and

an attitude control means for setting the rotorcraft to a specific attitude when releasing the parachute.

### Advantageous Effects

According to the present disclosure, a rotorcraft can be provided that enables a falling fuselage to assume a predetermined attitude and deploy its parachute more normally.

### BRIEF DESCRIPTION OF THE DRAWINGS

FIG. 1 shows a side view of a flying vehicle equipped with a parachute according to the present disclosure.

FIG. 2 shows a view of the flying vehicle of FIG. 1 when the parachute is deployed.

FIG. 3 shows a view from the top of a general standby flying object.

FIG. 4 shows a side view of a flying vehicle in a posture that makes it difficult to deploy the parachute normally.

FIG. 5 shows a side view of the flying vehicle equipped with a parachute according to the present disclosure, which is equipped with aerodynamic parts.

FIG. 6 shows a view of the flying vehicle of FIG. 5 when its posture is controlled during a fall.

FIG. 7 shows a side view of a flying vehicle equipped with a parachute according to the present disclosure, which is equipped with a mechanism for releasing an object connected to the airframe.

FIG. 8 shows a view of the flying vehicle of FIG. 7 when it releases an object connected to the airframe.

FIG. 9 shows a view of the flying vehicle of FIG. 7 when its attitude is controlled during a fall.

FIG. 10 shows another view of the flying vehicle equipped with a parachute according to the present disclosure, which is equipped with a mechanism for releasing an object connected to the airframe, from the side.

FIG. 11 shows a view of the flying vehicle of FIG. 10 when it releases an object connected to the airframe.

FIG. 12 shows a view of the flying vehicle equipped with a parachute according to the present disclosure when the airframe is partially disassembled.

FIG. 13 shows the flying vehicle of FIG. 12 when its attitude is controlled during a fall.

FIG. 14 shows a figure shows the flying vehicle equipped with a parachute according to the present disclosure when the aircraft is partially disassembled and separated from its fuselage.

FIG. 15 shows the flying vehicle of FIG. 14 when its posture is controlled during a fall.

FIG. 16 shows another view of the flying vehicle equipped with a parachute according to the present disclosure when it detaches and separates a part of its fuselage.

FIG. 17 shows a view of the flying vehicle of FIG. 16 from the top.

FIG. 18 shows a view of the flying vehicle of FIG. 16 when its attitude is controlled during a fall.

FIG. 19 shows a side view of the flying vehicle equipped with a parachute according to the present disclosure, which is equipped with a mechanism to change the center of gravity of the flying vehicle.

FIG. 20 shows a view of the flying vehicle of FIG. 19 when the center of gravity of the aircraft is shifted by moving the battery.

FIG. 21 shows the flying vehicle of FIG. 19 when its posture is controlled during a fall.

FIG. 22 shows a functional block diagram of the flight vehicle of FIG. 1.

### DETAILED DESCRIPTION OF THE EMBODIMENTS

The contents of the embodiments of this disclosure are described in the following. A rotorcraft equipped with a parachute according to an embodiment of the present disclosure consists of the following:

### Item 1

A rotorcraft equipped with a plurality of rotor blades, comprising:

a parachute mechanism that releases a parachute in a predetermined direction; and

an attitude control means for setting the rotorcraft to a specific attitude when releasing the parachute.

### Item 2

The rotorcraft according to Item 1,

wherein the attitude control means brings the airframe of the rotorcraft to the specific attitude by controlling the aerodynamic drag of the rotorcraft with respect to the predetermined direction.

### Item 3

The rotorcraft according to Item 2,

wherein the attitude control means is an aerodynamic adjustment member for creating a high aerodynamic drag portion and a low aerodynamic drag portion in the airframe.

### Item 4

The rotorcraft according to Item 2,

wherein the attitude control means controls the aerodynamic drag of the airframe by releasing an object connected to the airframe.

### Item 5

The rotorcraft of any one of Items 1-4,

wherein the attitude control means controls the aerodynamic drag of the airframe by partially disassembling the airframe.

### Item 6

The rotorcraft of any one of Items 1-4,

wherein the attitude control means controls the aerodynamic drag of the airframe by partially disassembling and separating the airframe.

### Item 7

The rotorcraft of any one of Items 1-6,

wherein the rotorcraft controls the aerodynamic drag of the rotorcraft by changing the position of the center of gravity of the rotorcraft with respect to a predetermined direction.

### Item 8

A method for controlling an attitude of a rotorcraft equipped with a plurality of rotor blades having a parachute mechanism, comprising:

an attitude control step for putting the rotorcraft into a specific attitude at least when releasing a parachute by the parachute mechanism; and

a parachute control step to control the parachute mechanism to release the parachute in a predetermined direction in the specified posture.

### Details of Embodiments According to this Disclosure

A rotorcraft equipped with a parachute according to the present disclosure will be described below with reference to the drawings.

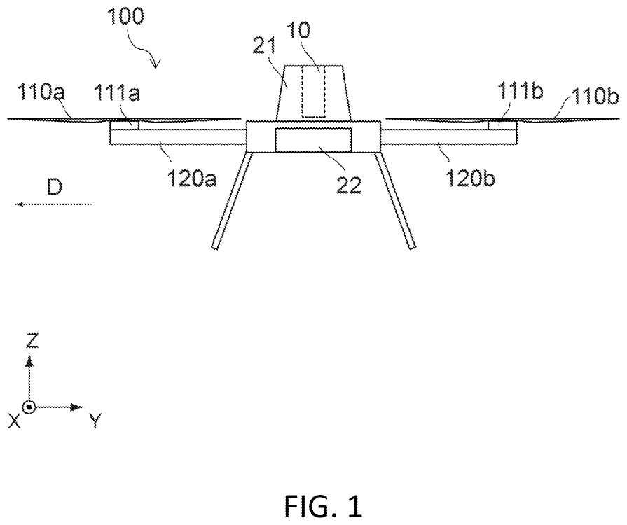

As shown in FIG. 1, the flying vehicle 100 according to the present disclosure is a rotorcraft equipped with a plurality of rotary wings, a parachute 10 in a specified direction, and an attitude control means for setting the rotorcraft in a specific attitude when releasing the parachute 10.

The flying vehicle 100 has at least a propeller 110 and a motor 111 and other elements for flight, and should be equipped with energy (e.g., secondary batteries, fuel cells, fossil fuels, etc.) to operate them.

The flying vehicle 100 shown in the figure is depicted in simplified form to facilitate the explanation of the structure of this disclosure, and detailed configurations, for example, the control unit, are not shown in the figure.

The flying vehicle 100 and the moving body 200 is moving in the direction of arrow D in the figure (in the −YX direction) as the direction of travel (see below for details).

In the following explanation, the terms may be used differently according to the following definitions.

Front-back direction: +Y direction and −Y direction, up-down direction (or vertical direction): +Z direction and Z direction, left-right direction (or horizontal): +X and −X directions, traveling direction (forward): −Y direction, backward (backward): +Y direction, ascending direction (up): +Z direction, descending direction (downward): −Z direction

Propellers 110a and 110b rotate under the output from a motor 111. The rotation of the propellers 110a and 110b generates propulsive force to take the flying vehicle 100 off from its starting point, move it, and land it at its destination. The propellers 110a and 110b can rotate to the right, stop, and rotate to the left.

As shown in FIG. 1, the flight vehicle 100 is equipped with a parachute 10, and the deployment means used for the parachute mechanism that releases the parachute 10 includes explosives, springs, and gases.

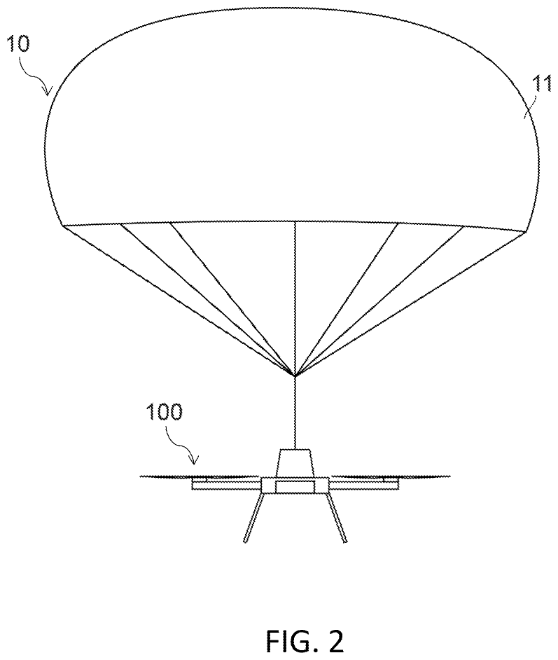

Although various methods are well known for the body of the parachute 10 and its deployment method, it is desirable for the body of the parachute 10 and its deployment method to be lightweight when equipped with a small and lightweight flying vehicle, such as a light aircraft weighing, for example, 25 kilograms. FIG. 2 shows an example of the deployment of the parachute 10. When the parachute 10 is released, a canopy 11 is deployed as shown.

The flying vehicle in the embodiment of this disclosure will be in a predetermined attitude prior to deployment of the parachutes 10 when deployment of the 10 parachutes is required or when there is an instruction to deploy the 10 parachutes.

The flying vehicle is equipped with sensors that can obtain information that can be used to determine whether to perform the deployment operation of the parachutes 10, by detecting the inclination and speed of the rotorcraft, as well as anomalies in various components.

When the parachute 10 needs to be deployed, the flying vehicle 100 is likely to fall or is already about to start falling. At this time, the flying vehicle will be in a predetermined attitude prior to the deployment of the parachute 10 equipped with the means for setting the rotorcraft to a specific attitude, according to the implementation of the present disclosure. The means for placing the rotorcraft in a specific attitude can be either effective in the pre-provisioned state of the rotorcraft without any additional action, or they can operate and be effective when the deployment of the parachute 10 becomes necessary.

The propeller 110 provided by the flying vehicle 100 of the present disclosure has one or more blades. The number of blades (rotors) may be any (e.g., one, two, three, four, or more blades). The shape of the blades can be any shape, such as flat, curved, twisted, tapered, or a combination thereof. The shape of the blades can be changeable (e.g., stretched, folded, bent, etc.). The blades can be symmetrical (having identical upper and lower surfaces) or asymmetrical (having differently shaped upper and lower surfaces). The blades can be formed into airfoils, wings, or any geometry suitable for generating dynamic aerodynamic forces (e.g., lift, thrust) when the blades are moved through the air. The geometry of the vane can be selected as appropriate to optimize the dynamic aerodynamic characteristics of the vane, such as increasing lift and thrust and reducing drag.

The propellers provided by the flying vehicles of this disclosure may be, but are not limited to, fixed pitch, variable pitch, and a mixture of fixed and variable pitch propellers.

The motor 111 produces rotation of the propeller 110; for example, the drive unit can include an electric motor or an engine. The blades can be driven by the motor and rotate around the axis of rotation of the motor (e.g., the long axis of the motor).

The blades can all rotate in the same direction or can rotate independently. Some of the blades rotate in one direction while others rotate in the other direction. The blades can all rotate at the same RPM, or they can each rotate at a different RPM. The number of rotations can be determined automatically or manually based on the dimensions of the moving body (e.g., size, weight) and control conditions (speed, direction of movement, etc.).

The flying vehicle 100 determines the number of revolutions of each motor and the angle of flight according to the wind speed and direction. This allows the flying vehicle to perform movements such as ascending and descending, accelerating and decelerating, and changing direction.

One means by which a flying vehicle 100 can put the rotorcraft in a particular attitude is by controlling aerodynamic drag. When an object falls, a lighter and more aerodynamic drag can reduce the rate of descent. Conversely, heavier and less air opposition will increase the rate of descent.

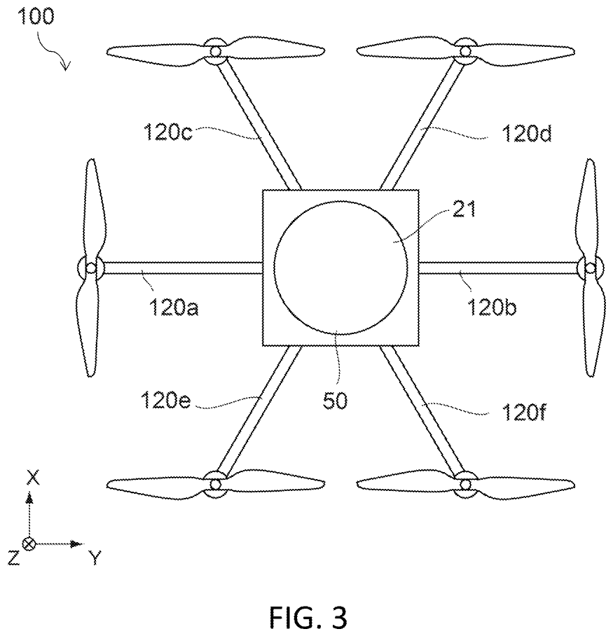

In rotorcraft, the shape of the rotorcraft when viewed from the top is often symmetrical and vertically symmetrical, as shown in FIG. 3, in order to improve its flight method and maneuverability, and the center of gravity of the rotorcraft is rarely biased to one end of the rotorcraft. Therefore, it is difficult to predict the falling posture of the fuselage, because it is difficult to generate large differences in the descent speed of each part of the fuselage.

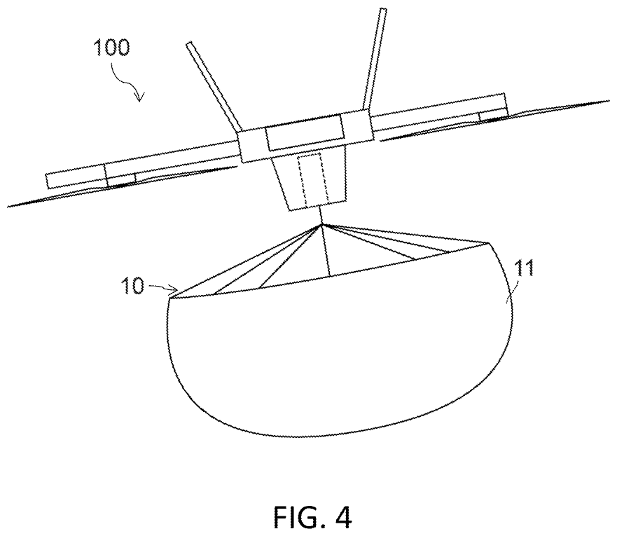

As shown in FIG. 4, the parachute 10 will not be fully effective if it falls into an attitude that makes it difficult to deploy it properly.

In order to drop the rotorcraft while maintaining a posture that allows the parachutes 10 to deploy normally, it is necessary to control the posture by reducing the rate of descent of at least one part of the rotorcraft or by increasing the rate of descent of at least one part of the rotorcraft.

The following are four examples of means to control aerodynamic drag and to put the rotorcraft in a particular attitude.

### Embodiment 1

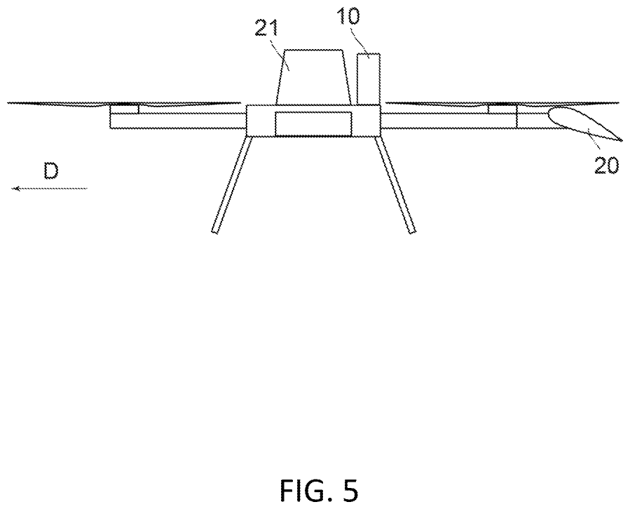

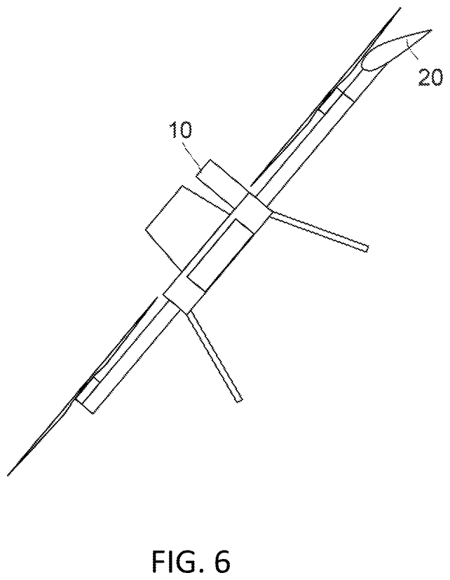

As shown in FIG. 5 and FIG. 6, the attitude control means provided by the flying vehicle 100 may be provided with an aerodynamic adjustment member 20 (so-called aeroparts, etc.), which is designed to create a high aerodynamic drag portion and a low aerodynamic drag portion in the airframe.

The aerodynamic adjustment member 20 functions as a tail wing, for example, during normal times, to improve flight stability during forward motion and to adjust the direction of travel of the rotorcraft. The aerodynamic adjustment member 20 may also control the attitude of the aircraft by increasing the aerodynamic drag on the side where the aerodynamic adjustment member 20 is installed when the aircraft is in a fall.

### Embodiment 2

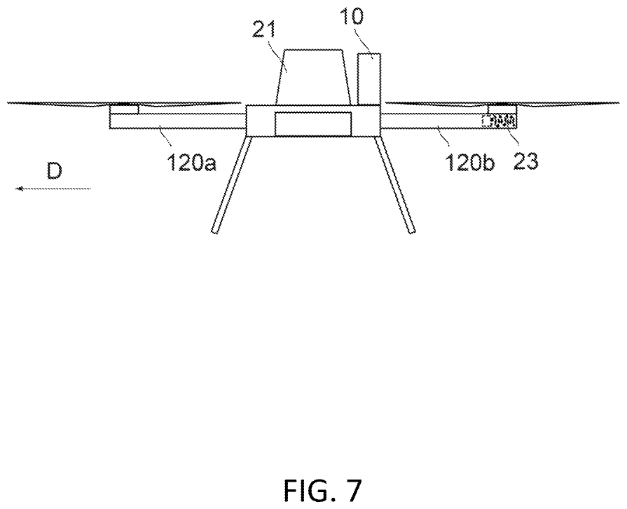

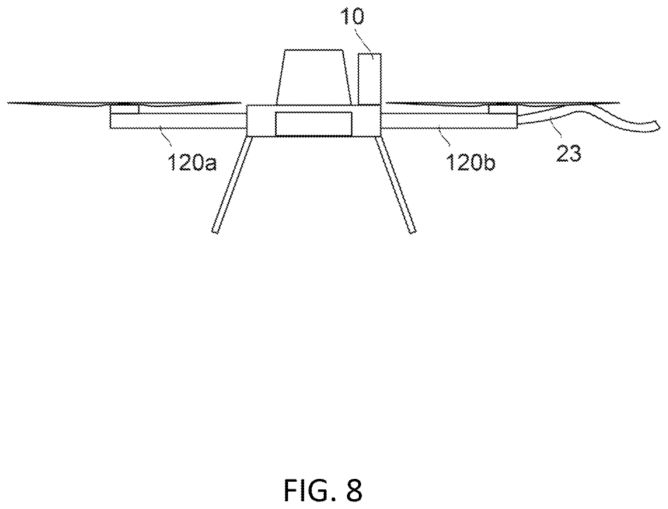

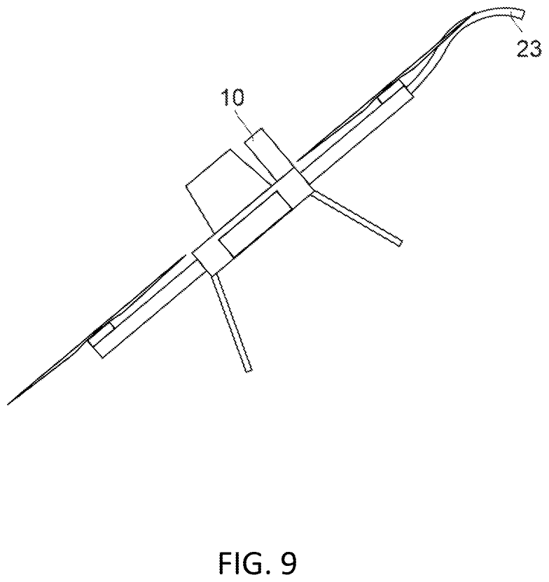

As shown in FIGS. 7 through 9, the attitude control means provided by the flying vehicle 100 may control the aerodynamic drag of the aircraft by releasing an object (part 23 for release) connected to the flying vehicle.

By releasing an object that can act as air resistance from the area where the descent speed is to be slowed down, the object will fall in an attitude in which the relevant area is facing upward. The object of air resistance should be lightweight in terms of weight and effectiveness. For example, a string, a long thin paper like a kite's tail, vinyl, or a plastic molding, etc. could be listed.

If a long, foldable or rollable object is used, it can be stored in an arm or frame, as shown in FIG. 7.

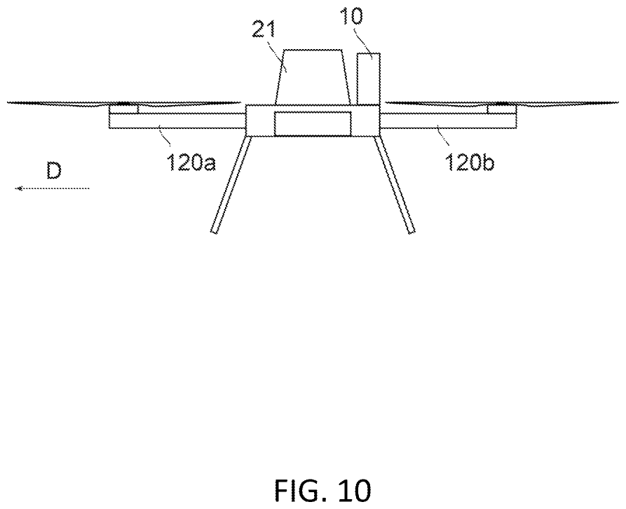

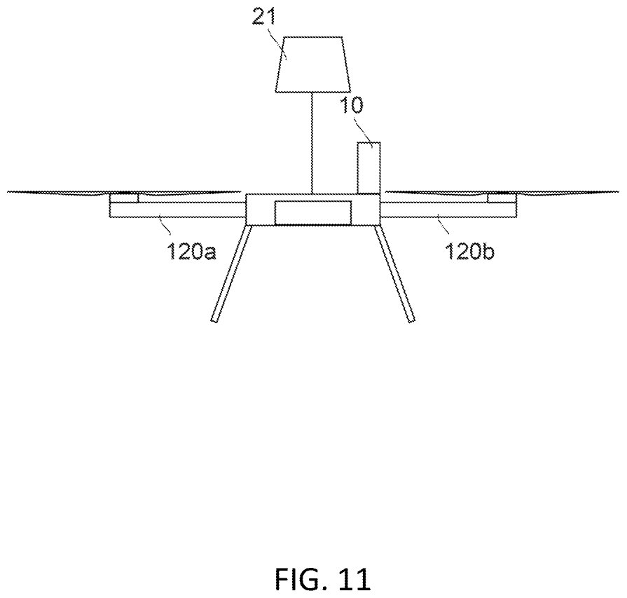

The same effect can also be obtained by releasing a cover 21 or the like connected by wires or the like to the main body of the flying vehicle 100, as shown in FIGS. 10 and 11. The well-known covers 21 of rotary wing aircraft are often dome-shaped, such as a hemisphere, to cover the control parts of the rotorcraft and its payload, and are often made of resin or other materials with low air permeability from the viewpoint of drip-proofing, etc. When the cover 21 has such a shape and material, it is expected to be highly effective as air resistance in the event of a fall.

### Embodiment 3

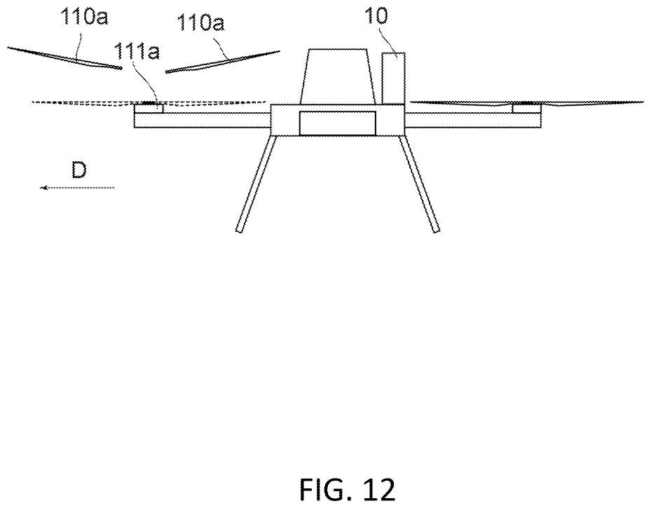

As shown in FIG. 12, the attitude control means provided by the flying vehicle 100 may control aerodynamic drag by at least partially disassembling the components of the flying vehicle.

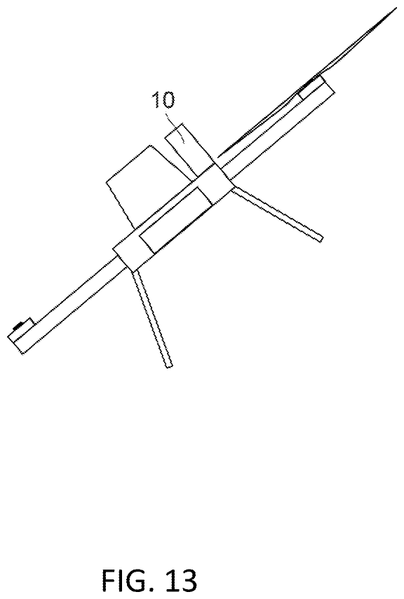

When some propeller 110 blades are disassembled, the area of the propeller 110 or the area of the rotating surface of the propeller 110 is lost, and the aerodynamic drag is reduced by that amount. The difference in aerodynamic drag between the side with the non-disassembled propeller 110 and the side with the disassembled propeller 110 results in a change in the attitude of the flying vehicle 100, as shown in FIG. 13.

Disassembling the components may include, for example, initiating by triggering the deployment of the parachute 10 and disassembling by removing a member, which fixes the blades of the plurality of propellers 110. Otherwise, disassembling the components may include destroying or disassembling the flying vehicle by impact using explosives or other means, depending on the use of the flying vehicle and where it will be used.

### Embodiment 4

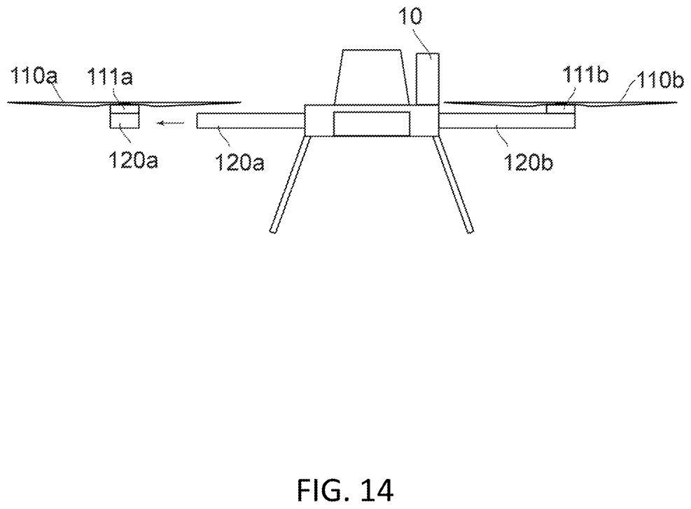

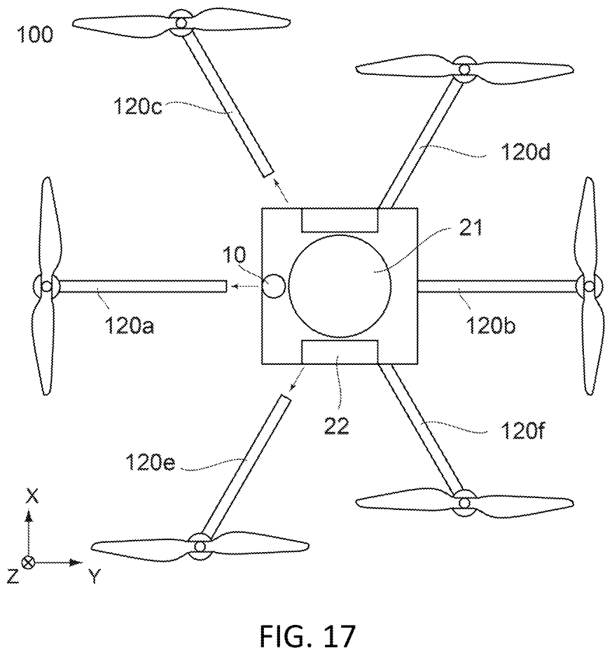

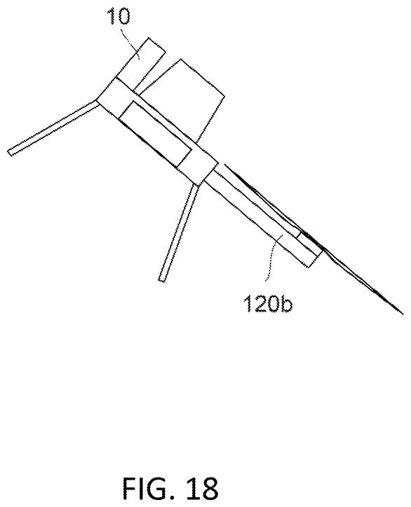

As shown in FIGS. 14 through 18, the attitude control means provided by the flying vehicle 100 may control aerodynamic drag by detaching and separating at least some of the flying vehicle's components and payload.

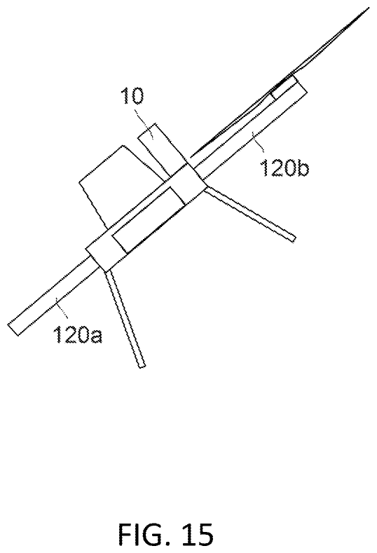

In FIGS. 14 and 15, cutting off part of the arm 120 of the flying vehicle 100 can reduce the aerodynamic drag of the corresponding part.

When detaching a relatively large structural component in this manner, the change in the center of gravity must be taken into consideration. By adjusting the amount of reduction in air resistance and the shift in the center of gravity due to detachment, it is possible to increase the fall speed of the side of the detached portion of the structural component and decrease the fall speed on the opposite side. Conversely, it is also possible to decrease the fall velocity of the side of the detached part and increase the fall velocity of the opposite side.

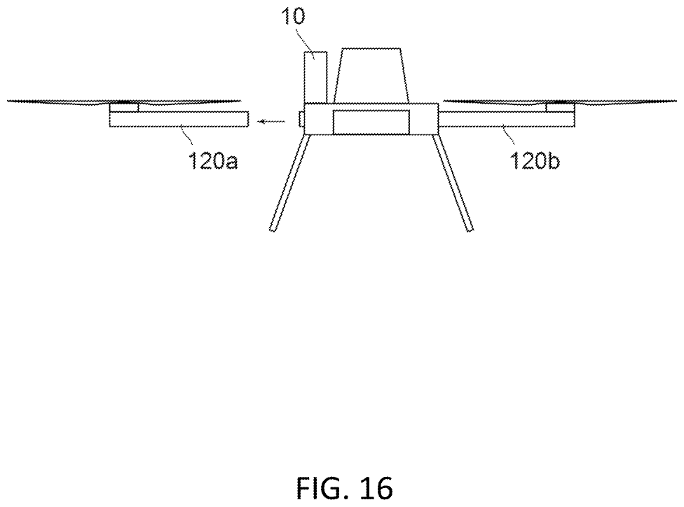

As shown in FIGS. 16 through 18, if the shift in the center of gravity exceeds the reduction in aerodynamic drag, the opposite side of the side in which the structural component is detached will fall faster.

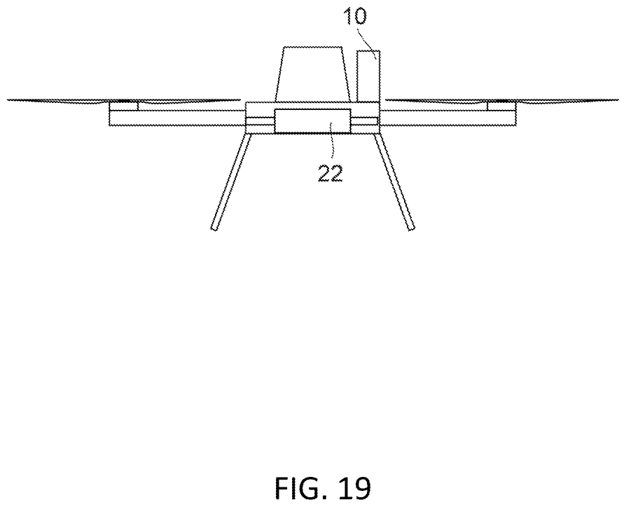

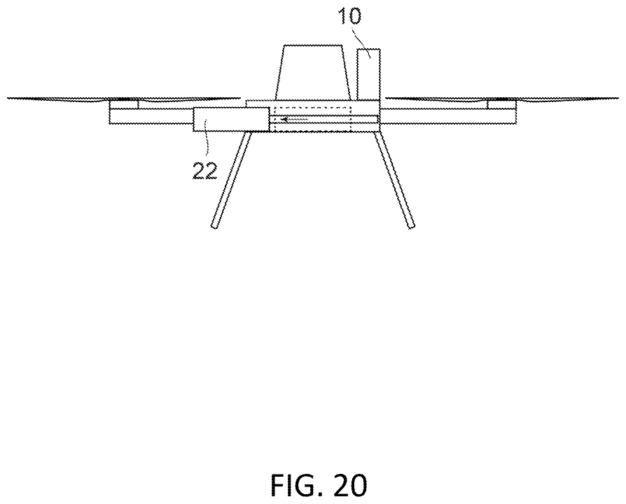

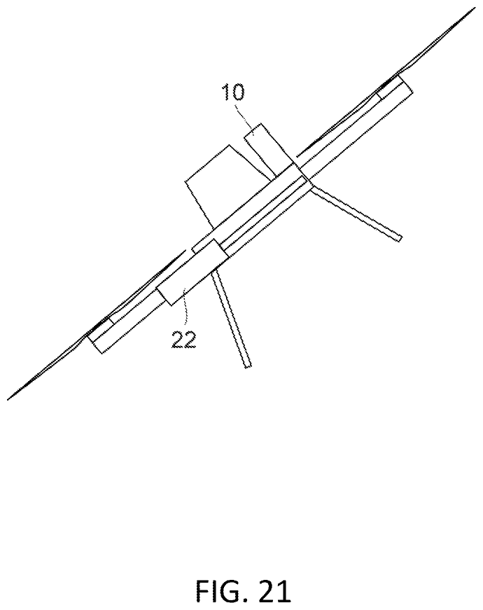

As shown in FIGS. 19 through 21, the flying vehicle 100 may control the attitude of the flying vehicle 100 by changing the position of the flying vehicle's center of gravity.

For example, the center of gravity of the aircraft can be shifted to one side and the falling attitude of the flying vehicle can be controlled by moving the batteries 22 and other objects on board. This control method can be implemented by using the objects originally carried by the rotorcraft and adding a mechanism to move the objects. Thus, the weight increase due to the mounting of the attitude control method may be minimized.

One method of moving objects carried by the rotorcraft is, for example, to slide them using rails. Specifically, the center of gravity of the flying vehicle 100 can be changed to a predetermined position and the falling posture can be controlled by fixing the batteries 22, luggage, and other objects on the rails and sliding them to a predetermined position by unfastening them when the center of gravity is moved, or by using a different system of means than the movement of the airframe.

Furthermore, the effectiveness of attitude control can be enhanced by combining the above four examples with each other as appropriate.

For example, if the aerodynamic adjustment member 20 of <Embodiment 1> is equipped with the release parts 23 of <Embodiment 2> in advance, the effect of released strings, etc. can be expected on top of the aerodynamic adjustment member 20's attitude control by aerodynamic resistance.

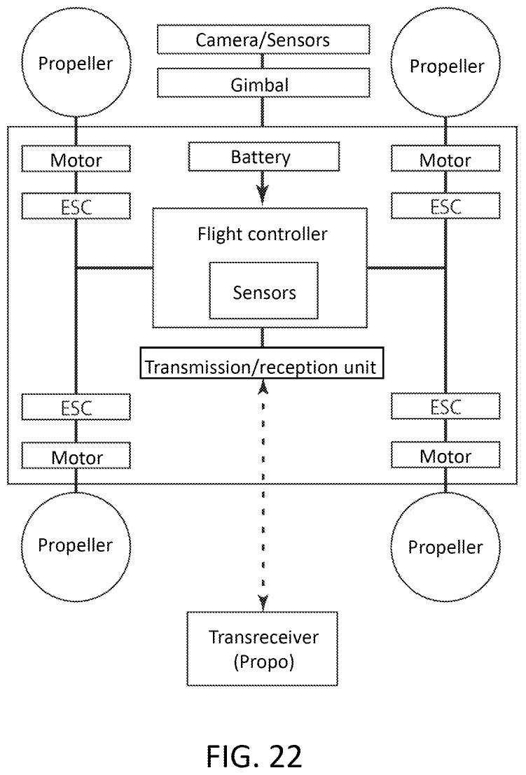

The flying vehicle described above has the functional blocks shown in FIG. 22. The functional blocks in FIG. 22 are a minimum reference configuration. The flight controller is a so-called processing unit. The processing unit can have one or more processors, such as a programmable processor (e.g., central processing unit (CPU)). The processing unit has a memory, not shown, which is accessible. The memory stores logic, code, and/or program instructions that can be executed by the processing unit to perform one or more steps. The memory may include, for example, a separable medium such as an SD card, random access memory (RAM), or an external storage device. Data acquired from a camera and sensors may be directly transmitted to and stored in the memory. For example, still and moving image data captured by a camera or other device is recorded in the internal or external memory.

The processing unit includes a control module configured to control the state of the rotorcraft. For example, the control module controls the six degrees of freedom (translational motion x, y, and z, and rotational motion θx, θy, and θz) of the rotorcraft to adjust the spatial arrangement, velocity, and/or acceleration of the rotorcraft, and to control the propulsion mechanism (e.g., motor) of the rotorcraft. The control module can control one or more of the states of a mounting part and sensors.

The processing unit is capable of communicating with a transmission/reception unit configured to transmit and/or receive data from one or more external devices (e.g., terminals, display units, or other remote controllers). The transmission/reception unit can use any suitable means of communication, such as wired or wireless communication. For example, the transmission/reception unit can use a local area network (LAN), wide area network (WAN), infrared, wireless, wireless, or WiFi, point-to-point (P2P) networks, telecommunication networks, cloud communication, etc. The transmission/reception unit can use one or more of the following: data acquired by sensors, processing results generated by the processing unit, predetermined control data, and user commands from a terminal or remote controller.

Sensors in this form may include inertial sensors (accelerometers, gyroscopes), GPS sensors, proximity sensors (e.g., lidar), or vision/image sensors (e.g., a camera).

The above-described embodiments are merely examples to facilitate understanding of the present disclosure and are not intended to limit or interpret the present disclosure. It goes without saying that the present disclosure may be changed and improved without departing from its intent, and that the present disclosure includes equivalents thereof.

### DESCRIPTION OF REFERENCE NUMERALS

### 10 Parachute

### 11 Canopy

20 Aerodynamic adjustment member

### 21 Cover

### 22 Battery

23 Parts for discharge
100 Flying vehicle (rotorcraft)

### 110 Propeller

### 111 Motor

120a-120f Arms

1. A rotorcraft equipped with a plurality of rotor blades, comprising:
a parachute mechanism that releases a parachute in a predetermined direction; and
an attitude control means for setting the rotorcraft to a specific attitude when releasing the parachute.

2. The rotorcraft according to claim 1,
wherein the attitude control means brings the airframe of the rotorcraft to the specific attitude by controlling the aerodynamic drag of the rotorcraft with respect to the predetermined direction.

3. The rotorcraft according to claim 2,
wherein the attitude control means is an aerodynamic adjustment member for creating a high aerodynamic drag portion and a low aerodynamic drag portion in the airframe.

4. The rotorcraft according to claim 2,
wherein the attitude control means controls the aerodynamic drag of the airframe by releasing an object connected to the airframe.

5. The rotorcraft according to claim 1,
wherein the attitude control means controls the aerodynamic drag of the airframe by partially disassembling the airframe.

6. The rotorcraft according to claim 1,
wherein the attitude control means controls the aerodynamic drag of the airframe by partially disassembling and separating the airframe.

7. The rotorcraft according to claim 1,
wherein the rotorcraft controls the aerodynamic drag of the rotorcraft by changing the position of the center of gravity of the rotorcraft with respect to a predetermined direction.

8. A method for controlling an attitude of a rotorcraft equipped with a plurality of rotor blades having a parachute mechanism, comprising:
an attitude control step for putting the rotorcraft into a specific attitude at least when releasing a parachute by the parachute mechanism; and
a parachute control step to control the parachute mechanism to release the parachute in a predetermined direction in the specified posture.

9. The rotorcraft according to claim 2,
wherein the attitude control means controls the aerodynamic drag of the airframe by partially disassembling the airframe.

10. The rotorcraft according to claim 3,
wherein the attitude control means controls the aerodynamic drag of the airframe by partially disassembling the airframe.

11. The rotorcraft according to claim 4,
wherein the attitude control means controls the aerodynamic drag of the airframe by partially disassembling the airframe.

12. The rotorcraft according to claim 2.
wherein the attitude control means controls the aerodynamic drag of the airframe by partially disassembling and separating the airframe.

13. The rotorcraft according to claim 3,
wherein the attitude control means controls the aerodynamic drag of the airframe by partially disassembling and separating the airframe.

14. The rotorcraft according to claim 4,
wherein the attitude control means controls the aerodynamic drag of the airframe by partially disassembling and separating the airframe.
